(19) United States
(12) Patent Application Publication
(10) Pub. No.: US 2026/0008338 A1
(43) Pub. Date: Jan. 8, 2026

(54) MULTI-FUNCTIONS SWITCH UNIT, AND MULTI-FUNCTIONS SWITCH MODULE

(71) Applicant: LS AUTOMOTIVE TECHNOLOGIES CO., LTD., Anyang-si, Gyeonggi-do (KR)

(72) Inventor: Ki Nyeong KO, Seoul (KR)

(73) Assignee: LS AUTOMOTIVE TECHNOLOGIES CO., LTD., Anyang-si, Gyeonggi-do (KR)

(21) Appl. No.: 18/878,803

(22) PCT Filed: Jun. 27, 2023
(86) PCT No.: PCT/KR2023/008893

§ 371 Date: Dec. 24, 2024

(30) Foreign Application Priority Data
Jun. 28, 2022 (KR) 10-2022-0079036
Jun. 21, 2023 (KR) 10-2023-0079456

(51) Int. Cl. B60K 35/10

(52) U.S. Cl. CPC B60K 35/10; B60K 2360/133; B60K 2360/782

(57) ABSTRACT

The present invention provides a multi-function switch unit (10) comprising a plurality of switch units (300, 300a, 500)) disposed spaced apart from each other in a housing (100), wherein each of the plurality of switch units is at least partially disposed on a single substrate (200).

### TECHNICAL FIELD

The present invention relates to a column type multi-function switch device and a multi-function switch module including the same, which is simplified in structure to increase the degree of design freedom and enhance the manufacturing cost reduction effect.

### BACKGROUND ART

For the mobility of vehicles such as automobiles, consumer demand is growing for various kinds of convenience features that can offer a more stable and comfortable driving state for users, beyond the vehicle's function as a means of transportation.

In general, a vehicle is provided with a starting device for security and safety. The starting device includes a start switch, an engine start unit, an ignition coil, a power distributor, and the like, which are installed inside the vehicle. In particular, the start switch is controlled to supply operating power required for starting the engine as well as operating other electrical devices.

In addition, for an essential functional element of a vehicle, such as a gearshift lever configured to change a gear shift range, the gear shift operation is performed by an electromechanical or electronic switch. Such a switching device entails advantages and disadvantages in terms of durability, the feel of manipulation, or cognition of manipulation depending on its type.

However, emphasis is placed on the importance of the durability and the cognition of the manipulation state by the user as the switching device is a vehicular device. A conventional switch structure according to the prior art involves problems associated with excessive space occupied by components and the inconvenience of manipulation due to structural constraints. Particularly, the individual arrangement of each component for the separate operation of the switch makes it considerably difficult to implement a compact switch device. Along with the incorporation of electrical and electronic components into automobiles, theses switches have an integrated structure. Such a switch device for vehicles is implemented in the form of a combined switch to enable the implementation of various functions.

Nevertheless, in the case where the conventional vehicular switch device takes the form of the combined switch, it requires a plurality of substrates to arrange each switch detecting sensor, thereby narrowing the arrangement space, and thus leading to limitations in the assembly process. Furthermore, the arrangement of the plurality of substrates results in increases in the process and manufacture costs.

### DISCLOSURE OF INVENTION

### Technical Problem

Accordingly, the present invention has been made to solve the above-mentioned problems occurring in the prior art, and it is an object of the present invention to provide a multi-function switch device and module that minimizes the number of substrates to facilitate the manufacturing process and significantly reduce the manufacturing costs, while maintaining a combined switch configuration.

### Technical Solution

To achieve the above object, in one aspect, the present invention provides a multi-function switch device (10) including a plurality of switch units disposed spaced apart from each other in a housing (100), wherein each of the plurality of switch units is at least partially disposed on a single substrate (200).

In the multi-function switch device, the plurality of switch units may include: a composite switch unit (300) configured to detect both an axial rotation about a shaft located at least partially within the housing (100) and an axial movement in an axial direction; and a button switch unit (500) disposed at one end on the other peripheral surface of the housing (100) so as to be exposed to the outside.

In the multi-function switch device, the composite switch unit (300) may include: a composite knob (310) disposed on the outer side of the hosing (100); a composite sensing holder part (340) configured to be axially rotatable or movable in response to the movement of the composite knob (310); a composite sensing moving part (320) disposed at the composite sensing holder part (340); and a composite sensing fixed part (330) disposed on the substrate (200) so as to correspond to the position of the composite sensing moving part (320) and configured to detect the movement state of the composite sensing moving part (320). In the multi-function switch device, the composite sensing holder part (340) may include: a sensing holder (350) configured to allow the composite sensing moving part (320) to be disposed therein, the sensing holder (350) being movable relative to the composite knob (310); and a sensing elastic part (360) configured to allow the sensing holder (350) to return its original position when an external force applied to the composite knob (310) for the axial movement of the sensing holder (350) is removed.

In the multi-function switch device, the sensing holder (350) may include: a holder body (351) configured to allow the composite sensing moving part (320) to be seated thereon; a holder-connecting shaft (353) connected at one end to the holder body (351); and a holder support (355) connected to the other end of the holder-connecting shaft (353) so to be movable relative to the housing (100).

In the multi-function switch device, the holder support (355) may have a non-circular cross-sectional shape.

In the multi-function switch device, the composite sensing fixed part (330) may be provided in a plural number.

In the multi-function switch device, the respective distances between the center of the axial rotation of the composite sensing moving part (320) and the plurality of composite sensing fixed parts (330) may be the same as each other on a plane perpendicular to the rotary axis of the composite sensing moving part (320).

In the multi-function switch device, the respective distances between the center of the axial rotation of the composite sensing moving part (320) and the plurality of composite sensing fixed parts (330) may be different from each other on a plane perpendicular to the rotary axis of the composite sensing moving part (320).

In the multi-function switch device, when the composite sensing moving part (320) is projected onto the substrate (200), the composite sensing fixed parts (330) May be overlapped with at least a part of the inside of the projection area of the composite sensing moving part (320).

In the multi-function switch device, the normal to one surface of the substrate (200) and the axis of the axial rotation of the composite sensing moving part (320) may be arranged to be orthogonal to each other.

In the multi-function switch device, the housing 100 may further include a housing holder guide (140) configured to guide the axial movement of the composite sensing holder part (340).

In the multi-function switch device, the housing (100) may further include a housing rotary guide (130) configured to guide the axial rotation of the composite sensing holder part (340).

In the multi-function switch device, the internal separation distances between the substrate (200) and the housing (100) at the points where the button switch unit 500 and the composite switch unit (300) are located may be the same.

In the multi-function switch device, the internal separation distances between the substrate (200) and the housing (100) at the points where the button switch unit 500 and the composite switch unit (300) are located may be different.

In the multi-function switch device, the composite knob (310) may include: a composite rotary knob (311) disposed at one end of the housing (100) so as to be axially rotatable; and a composite axial knob (313) disposed at an end of the composite rotary knob (311) so as to be movable in the longitudinal direction of the rotary axis of the composite rotary knob (311).

In the multi-function switch device, the composite sensing moving part (320) may include a magnet or a ferromagnetic material.

In the multi-function switch device, the button switch unit 500 may include: a button switch knob (510) disposed so as to be exposed to the outside; a button switch sensing fixed part (520) disposed on the substrate (200); and a button switch sensing moving part (530) connected at one end to the underside of the button switch knob (510) and connected at the other end to the top of the button switch sensing fixed part (520) to form a signal change of the button switch sensing fixed part (530).

In the multi-function switch device, the multi-function switch unit 10 may include a switch light source unit (600) configured to generate and provide a light which is to be outputted through the button switch unit (500).

In the multi-function switch device, the substrate (200) may be positioned inside the housing (100) in such a manner as to be disposed oppositely spaced apart from the exposed portion of the button switch unit (500), and the composite switch unit (300) may be at least partially disposed in a space defined between the substrate (200) and the exposed portion of the button switch unit (500).

In the multi-function switch device, the substrate (200) may be positioned inside the housing (100) in such a manner as to be disposed in proximity to the exposed portion of the button switch unit (500).

In the multi-function switch device, the composite switch unit (300) may be a shift range selector switch configured to select the shift range of the vehicle, and the button switch unit (500) may be a start switch for the vehicle.

In another aspect, the present invention provides a multi-function switch module (1) including: a multi-function switch device (10) including a plurality of switch units disposed spaced apart from each other in a housing (100), wherein each of the plurality of switch units is at least partially disposed on a single substrate (200); a storage unit (3) configured to a detected initial state value of at least one of the plurality of switch units and a preset value used as an operation state determination criterion of at least one of the plurality of switch units; and a control unit (2) configured to calibrate an actually detected state value or the preset value of at least one of the plurality of switch units based on the initial state value stored in the storage unit.

### Advantageous Effects

The multi-function switch device according to an embodiment of the present invention as constructed above can minimize the number of substrates to simplify the manufacturing process and significantly reduce the manufacturing costs, as well as can minimize a space required for design to increase the process yield.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a schematic perspective view illustrating a state in which a multi-function switch device according to an embodiment of the present invention is disposed at a lower end of a steering wheel for a vehicle;

FIG. 2 is a schematic partial perspective view illustrating a multi-function switch device according to an embodiment of the present invention;

FIG. 3 is a partially exploded perspective view illustrating a multi-function switch device according to an embodiment of the present invention;

FIG. 4 is a schematic partial cross-sectional view illustrating a multi-function switch device according to an embodiment of the present invention;

FIG. 5 is a schematic partial perspective view illustrating a composite switch unit of a multi-function switch device according to an embodiment of the present invention;

FIGS. 6 and 7 are schematic views illustrating the states before and after the operation of a composite switch unit according to an axial pushing operation thereof in a multi-function switch device according to an embodiment of the present invention;

FIG. 8 is a schematic top plan view illustrating the state in which a plurality of composite sensing fixed parts are symmetrically aligned and the composite sensing fixed parts are positioned within the projection area of a composite sensing moving part when the composite sensing moving part is not in operation in a multi-function switch device according to an embodiment of the present invention;

FIG. 9 is a schematic top plan view illustrating the state in which a plurality of composite sensing fixed parts are symmetrically aligned and the composite sensing fixed parts are at least partially positioned to extend beyond the projection area of a composite sensing moving part when the composite sensing moving part is in operation in a multi-function switch device according to an embodiment of the present invention;

FIGS. 10 and 11 are schematic side cross-sectional views illustrating the symmetric and asymmetric alignment states of a plurality of composite sensing fixed parts in a multi-function switch device according to an embodiment of the present invention;

FIG. 12 is a schematic top plan view illustrating the state in which the central line of a plurality of composite sensing fixed parts and the central line of the projection area of a composite sensing moving part are asymmetrically aligned and the composite sensing fixed parts are positioned within the projection area of the composite sensing moving part when the composite sensing moving part is not in operation in a multi-function switch device according to an embodiment of the present invention;

FIG. 13 is a schematic top plan view illustrating the state in which the central line of a plurality of composite sensing fixed parts and the central line of the projection area of a composite sensing moving part are asymmetrically aligned and the composite sensing fixed parts are at least partially positioned to extend beyond the projection area of a composite sensing moving part when the composite sensing moving part is in operation in a multi-function switch device according to an embodiment of the present invention;

FIG. 14 is a schematic partial cross-sectional view illustrating a multi-function switch device according to an embodiment of the present invention;

FIG. 15 is a schematic partial perspective view illustrating a sensing holder of a multi-function switch device according to an embodiment of the present invention;

FIG. 16 is a schematic partial perspective view illustrating a modification of a composite sensing moving part of a multi-function switch device according to an embodiment of the present invention;

FIG. 17 is a schematic perspective view illustrating the state in which a switch light source unit is disposed adjacent to button switch sensing fixed parts of a multi-function switch device according to an embodiment of the present invention;

FIG. 18 is a schematic partial cross-sectional view illustrating the light output state of a switch light source unit of a multi-function switch device according to an embodiment of the present invention;

FIG. 19 is a schematic partial cross-sectional view illustrating the arrangement state of a multi-function switch device according to another embodiment of the present invention;

FIGS. 20 and 21 are schematic partial cross-sectional views illustrating a modification of the support structure of a composite sensing holder part of a multi-function switch device according to an embodiment of the present invention; and

FIG. 21 is a schematic block diagram illustrating the configuration of a multi-function switch module according to an embodiment of the present invention.

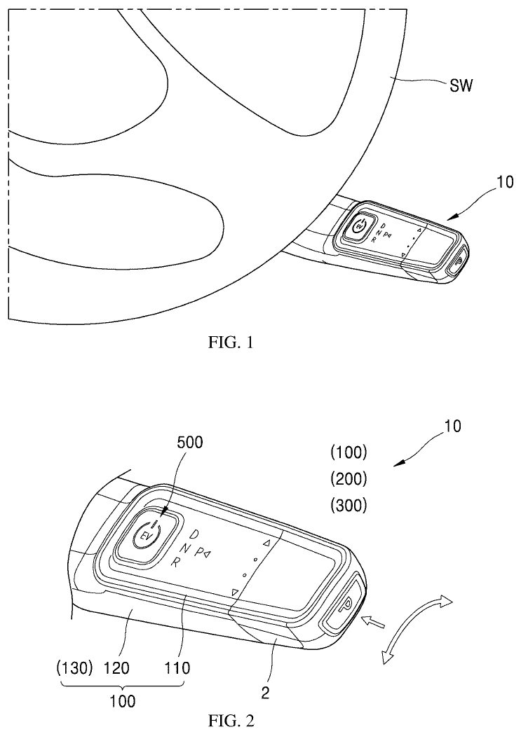

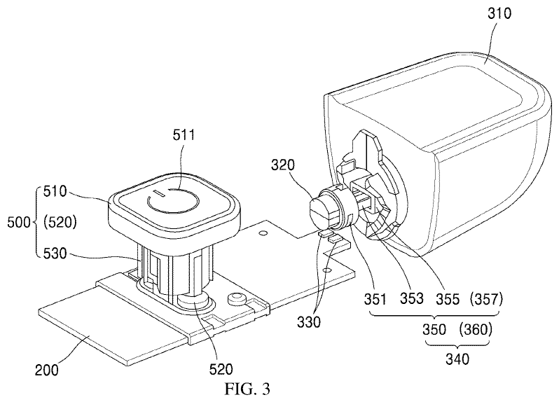

### BEST MODE FOR CARRYING OUT THE INVENTION

Now, the preferred embodiments of the present invention will be described hereinafter in detail with reference to the accompanying drawings. It should be noted that the same elements in the drawings are denoted by the same reference numerals although shown in different figures. In the following description, the detailed description on known function and constructions unnecessarily obscuring the subject matter of the present invention will be avoided hereinafter.

A multi-function switch device 10 according to an embodiment of the present invention includes a plurality of switch units 300 and 500. In this embodiment, the multi-function switch device 10 is implemented as a column-type switch disposed on a side of a steering wheel SW of a vehicle. The following description focuses on the case where the multi-function switch device 10 includes a shift range selector switch unit, which selects the shift range of the vehicle, and a start switch unit.

The multi-function switch device 10 of the present invention includes a plurality of switch units 300 and 500. In this case, each of the plurality of switch units is at least partially disposed on a single substrate 200. In other words, the multi-function switch device 10 allows an electrical signal flow to be formed between the plurality of switch units 300 and 500 by means of the common single substrate. That is, the multi-function switch device 10 adopts a configuration in which the design of the plurality of switch units 300 and 500 is simplified using the common single substrate to make compact an internal arrangement structure thereof and reduce the manufacturing costs.

More specifically, the multi-function switch device 10 according to an embodiment of the present invention includes a housing 100. The housing 100 is connected to a lower side of the steering wheel SW to allow a column-type switch to be implemented. The housing 100 includes a housing cover 110 and a housing body 120. The housing cover 110 and the housing body 120 are engaged with each other to define an internal space therebetween so that other constituent elements are disposed stably in the internal space.

Icons such as D, N, R, and P, which indicate the shift range of the vehicle, are arranged on the outer surface of the housing cover 110. Various configurations may be applied to these icons, further including a separate configuration for internal light irradiation.

A substrate 200 is disposed inside the housing cover 110 and the housing body 120. Sensing elements of the plurality of switch units 300 and 500 are arranged together on the substrate 200 so as to adopt a configuration that enables signal transmission via a single substrate, thus eliminating structural complexity. This design also reduces the manufacturing costs and minimizes the required arrangement space, thereby improving assemblability.

The plurality of switch units includes a composite switch unit 300 and a button switch unit 500. The composite switch unit 300 is implemented as a switch unit that performs a combined sensing function of detecting an axial rotation about a shaft located at least partially within the housing 100 and an axial movement in an axial direction. In this embodiment, the composite switch unit 300 is implemented as a shift range selector switch unit. The button switch unit 500 is disposed at one end on the other peripheral surface of the housing 100 so as to be exposed to the outside. The button switch unit 500 is implemented as a start switch unit such as a start-stop button (SSB).

First, the composite switch unit 300, which is implemented as the shift range selector switch unit, includes a composite knob 310, a composite sensing holder part 340, a composite sensing moving part 320, and a composite sensing fixed part 330.

The composite knob 310 is disposed on the outer side of the housing 100, and the composite sensing holder part 340 is axially rotatable or movable in response to the movement of the composite knob 310. The composite sensing moving part 320 is disposed on the composite sensing holder part 340, and the composite sensing fixed part 330 is disposed on the substrate 200 so as to correspond to the position of the composite sensing moving part 320 to detect the movement state of the composite sensing moving part 320.

More specifically, the composite switch unit 300 has a configuration in which the composite knob 310 is disposed on the outer side of the housing 100 so as to be movable relative to the housing 100. In detail, the composite knob 310 includes a composite rotary knob 311 and a composite axial knob 313.

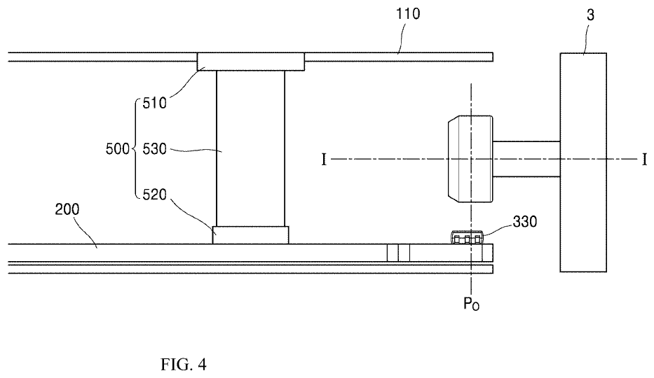

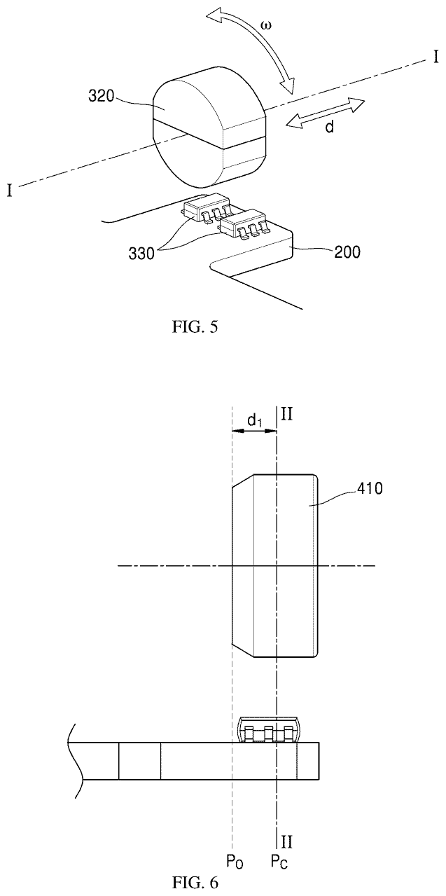

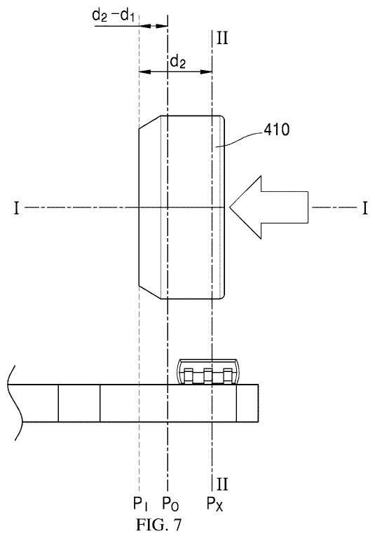

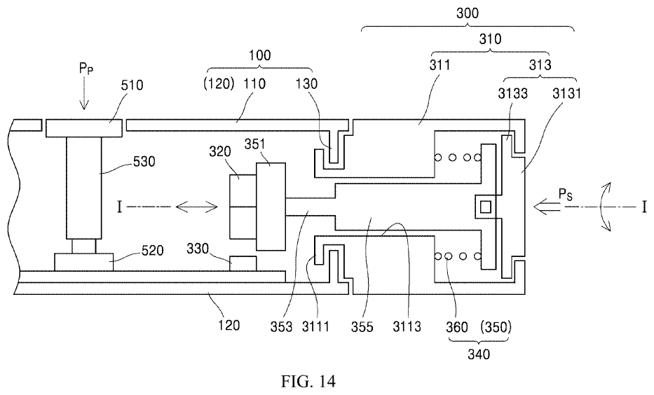

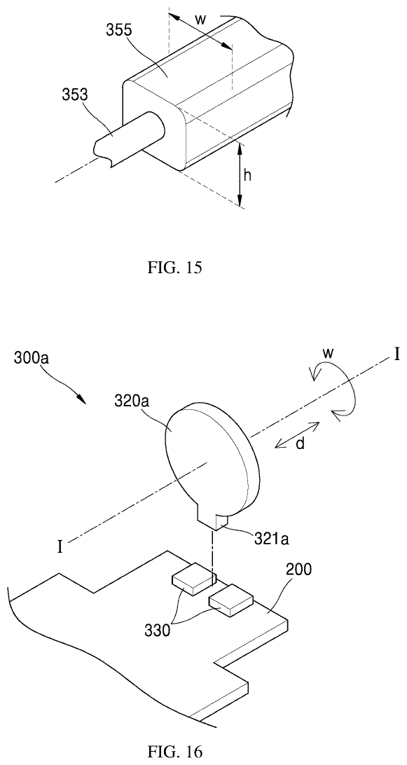

The composite rotary knob 311 (see FIG. 14) is disposed at one end of the housing 100 so as to be axially rotatable. The composite rotary knob 311 is disposed at one end of the housing 100 so as to be axially rotatable relative to the housing 100 so that the composite rotary knob 311 axially rotates about a line I-I (see FIGS. 4 and 5).

The composite rotary knob 311 axially rotates about the line I-I, which is a central axis thereof, and may further include an element that enables a stable axial rotation. The composite rotary knob 311 has a rotary knob guide 3111 formed at one side thereof and the housing 100 further includes a housing rotary guide 130. The housing rotary guide 130 is formed to extend inwardly from the inner surfaces of the sides of the housing cover 110 and the housing body (120). The housing rotary guide 130 and the rotary knob guide 3111 are configured to engage with each other in a relatively rotatable manner. This relatively rotatable engagement enables the composite rotary knob 311 to smoothly rotate axially relative to the housing 100, and prevents any unintended separation between the composite rotary knob 311 and the housing 100.

Although not specified in detail in this embodiment, a separate stopper may be provided on the housing rotary guide 130 and the rotary knob guide 3111 to limit the range of the relative rotational angle. In addition, a separate detent element may be provided on the housing rotary guide 130 and the rotary knob guide 3111 so that various modifications can be made such as adopting a structure of providing a specific detent feel when the composite rotary knob 311 axially rotates relative to the housing 100.

Meanwhile, the composite axial knob 313 is disposed at an end of the composite rotary knob 311. The composite axial knob 313 is disposed so as to be movable along the longitudinal direction of the rotary axis of the composite rotary knob 311. The composite rotary knob 311 has a rotary knob support through-hole 3113 formed at the center thereof so as to extend along the longitudinal axis of the composite rotary knob 311. The rotary knob support through-hole 3113 is formed in the composite rotary knob 311 so as to penetrate through the longitudinal axis of the composite rotary knob 311. The sensing holder 350 of the composite sensing holder part 340, which will be described later, is penetratingly disposed in the rotary knob support through-hole 3113. The composite sensing holder part 340 can rotate or move axially in response to the movement of the composite knob 310, and the sensing holder 350 of the composite sensing holder part 340 is movably disposed through the rotary knob support through-hole 3113 to enable a push switch operation in a predetermined axial direction.

The composite sensing holder part 340 includes a sensing holder 350 and a sensing elastic part 360. The composite sensing moving part 320 is disposed on the sensing holder 350, which is movable relative to at least a part of the composite knob 310. In other words, as described later, the sensing holder 350 may adopt a configuration in which it moves relative to at least a part of the composite knob 310 in the axial direction of the line I-I.

The sensing elastic part 360 is disposed within the composite rotary knob 311. One end of the sensing elastic part 360 is elastically supported by the composite rotary knob 311 and the other end of thereof is brought into contact with the sensing holder 350 or the composite axial knob 313 in an elastically supported manner. By virtue of this configuration of the sensing elastic part 360, after an external force applied to the composite axial knob 313 has been removed, the sensing holder 350 can return to its original position.

The sensing holder 350 includes a holder body 351, a holder-connecting shaft 353, and a holder support 355. The holder body 351 is opened at one side toward the rotary axis of the line I-I to allow the composite sensing moving part 320 to be seated thereon. The holder-connecting shaft 353 is connected to the other side of the holder body 351. The holder-connecting shaft 353 is connected at one end to the holder body 351 and is connected at the other end to the holder support 355 so as to be oriented toward the composite axial knob 313.

The holder support 355 is connected to the other end of the holder-connecting shaft 353 so as to be movable relative to the housing 100. The holder support 355 is disposed in the rotary knob support through-hole 3113 as described previously so that the holder support 355 can move in the axial direction indicated by the line I-I.

In this case, it is obvious from the foregoing that the holder support 355 and the rotary knob support through-hole 3113 are configured to have corresponding cross-sectional structures so as to prevent any interference occurring during their relative movement.

Additionally, the holder support 355 of the present invention preferably has a non-circular cross-sectional shape. In other words, the holder support 355 and the rotary knob support through-hole 3113 have the non-circular cross-sectional shape so that when the composite sensing holder part 340 on which the composite sensing moving part 320 is seated rotates axially about the rotary axis of the line I-I, the relative rotation between the composite rotary knob 311 and the composite sensing holder part 340 can be prevented.

Although it has been shown in this embodiment that the holder support 355 and the rotary knob support through-hole 3113 has a rectangular cross-sectional shape with chamfered corners, they may be modified in various manners within the range in which the cross-section of the holder support 355 and the rotary knob support through-hole 311 forms a structure of preventing their relative rotation, such as having an elliptical shape, a rectangular shape, or a square shape.

The other end of the holder support 355 is connected to the composite axial knob 313. A holder elastic support 357 is formed at an end of the holder support 355, if necessary, and is brought into contact with the other end of the sensing elastic part 360 so as to be elastically supported by the sensing elastic part 360. In this case, a holder elastic support engaging part is formed at an end or a side of the holder elastic support 357 to allow the composite axial knob 313 to be engagingly connected thereto. The composite axial knob 313 includes an axial knob body 3131 and an axial knob body stopper 3133.

The axial knob body stopper 3133 is formed on the outer circumferential surface of the axial knob body 3131 in a radially outwardly extending manner. The axial knob body stopper 3133 is engaged with a rotary knob stopper formed at an end of the composite rotary knob 311 so that unintended separation of the axial knob body 3131 from the composite rotary knob 311 can be prevented.

The composite sensing moving part 320 and the composite sensing fixed part 330 may detect the switching operation of the composite switch unit 300 to output a switching signal. The composite sensing moving part 320 is disposed on the composite sensing holder part 340. When the composite rotary knob 311 or the composite axial knob 313 is rotated or pressed by a user, the composite sensing moving part 320, which is disposed on the composite sensing holder part 340, also rotates or moves, leading to a change in position. In this case, the composite sensing fixed part 330 is disposed on one surface of the substrate 200 and detects the positional change when the composite sensing moving part 320 rotates or moves axially.

In this embodiment, the composite sensing moving part 320 is implemented as a magnet, and the composite sensing fixed part 330 is implemented as a magnetic sensor including a hall sensor and the like that detect the movement state, i.e., the positional change of the composite sensing moving part 320 to output a changed signal.

In other words, when the composite rotary knob 311 or the composite axial knob 313 is rotated or pressed by the user, the composite sensing moving part 320, which is disposed on the composite sensing holder part 340, also rotates or moves, leading to the change in position. This positional change may lead to a change in the magnetic field and the composite sensing fixed part 330, which is implemented as the hall sensor, may detect the change in the magnetic field to output a predetermined switching operation signal.

The composite sensing fixed part 330 according to the present invention may be provided in a singular or plural number. The redundancy of this plural arrangement may provide a stable operation state. In other words, by virtue of the arrangement of the plurality of composite sensing fixed parts 330, when an erroneous operation occurs in any one of the composite sensing fixed parts 330, an output signal from the other thereof may be utilized to ensure a stable switching operation.

In the meantime, when the plurality of composite sensing fixed parts 330 are disposed as described above, the kinematic relationship between the plurality of composite sensing fixed parts 330 and the composite sensing moving part 320 of the present invention may be established or adjusted.

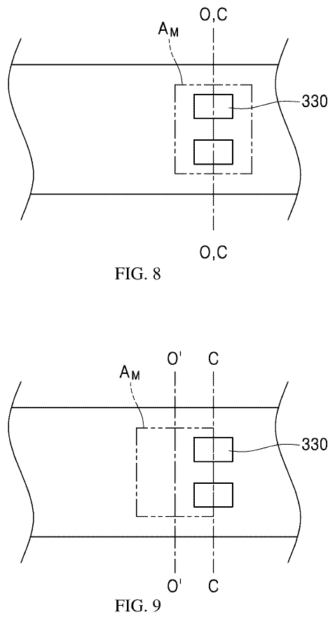

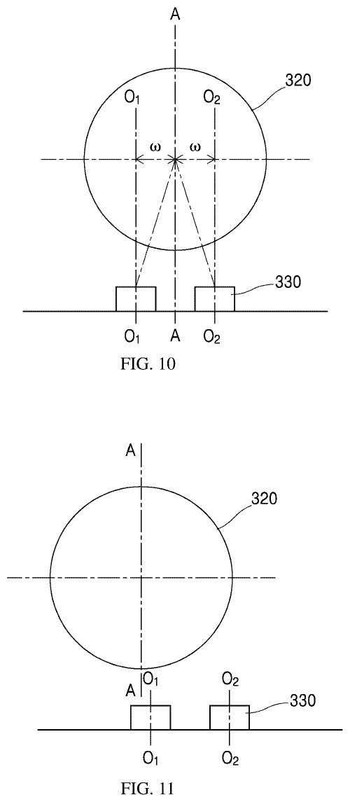

In other words, in the case of the composite sensing moving part and the composite sensing fixed parts according to an embodiment of the present invention, as shown in FIGS. 8 and 10, the composite sensing fixed parts may be symmetrical in position with respect to the rotary axis line I-I of the composite sensing moving part 320, if necessary.

Under the application of no external force, the respective distances between the center of the axial rotation of the composite sensing moving part 320 and the plurality of composite sensing fixed parts 330 are the same as each other on a plane perpendicular to the rotary axis of the composite sensing moving part 320.

FIG. 10 illustrates a schematic side cross-sectional view of the symmetrical position relationship between the composite sensing moving part 320 and the plurality of composite sensing fixed parts 330 on a plane perpendicular to the rotary axis line I-I of the composite sensing moving part 320. The composite sensing moving part 320 has a circular arrangement structure on the drawing sheet, and the center of the rotary operation is positioned on the line A-A.

In this case, a pair of the composite sensing fixed parts 330 are arranged on the substrate 200. As shown in FIG. 10, the central lines of the composite sensing fixed parts 330 are denoted by lines O₁-O₁ and O₂-O₂, respectively, and the distances between the lines O₁-O₁ and A-A, and between the lines O₂-O₂ and A-A have the same and are represented by a reference symbol ω. This symmetrical position relationship may enable securing a stable detection function.

FIGS. 8 and 9 illustrate the substrate 200 when viewed from a top plan view. In FIGS. 8 and 9, the position of the composite sensing moving part 320 is projected onto an area indicated by the reference symbol AM. When the composite sensing moving part 320 is projected onto the substrate 200, the composite sensing fixed parts 330 are overlapped with at least a part of the inside of the projection area of the composite sensing moving part 320. In addition, herein, the line O—O denotes the central line of the composite sensing moving part 320 and the line C-C denotes the central line of the composite sensing fixed part 330 before a pressing force for the push operation is applied to the composite axial knob 313 by a user. The line O′-O′ denotes the central line of the composite sensing moving part 320 after the composite sensing moving part 320 moves by a distance (d) as the pressing force for the push operation is applied to the composite axial knob 313 by the user.

In other words, when the composite sensing moving part 320 moves through the push operation of the composite axial knob 313, there occurs a change in the area where the projection area of the composite sensing moving part 320, which is indicated by the reference symbol AM, is overlapped with the composite sensing fixed part 330, so that the composite sensing fixed parts 330 detects a change in the magnetic field formed by the composite sensing moving part 320 and outputs a changed detection signal.

Further, meanwhile, as described above, the composite sensing fixed parts 330 of the present invention is not limited to the lateral symmetrical arrangement structure as shown in FIG. 10.

The respective distances between the center of the axial rotation of the composite sensing moving part 320 and the plurality of composite sensing fixed parts 330 may be different from each other on a plane perpendicular to the rotary axis of the composite sensing moving part 320. As shown in FIG. 11, the composite sensing fixed parts 330 of the present invention are configured such that the central line O₁-O₁ of any one of the composite sensing fixed parts 330 is almost consistent with the central line A-A of the composite sensing moving part 320, while the central line O₂-O₂ of the other composite sensing fixed part 330 is spaced apart from the central line A-A of the composite sensing moving part 320. This configuration allows the two composite sensing fixed parts 330 to output different detection signals even when no external force is applied.

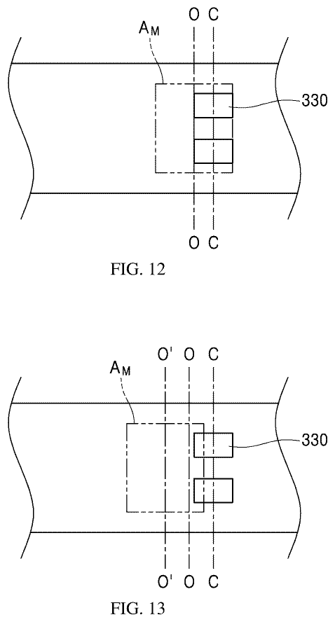

FIGS. 12 and 13 illustrate a planar projection state of the embodiment of FIG. 11. In other words, the position of the composite sensing moving part 320, which is projected onto the substrate 200, is shown in an area indicated by the reference symbol AM. The line C-C denotes the central line of the composite sensing fixed parts 330, while the lines O-O and O′ and O′ denote the central lines of the composite sensing moving part 320 before and after the pressing force for the push operation is applied to the composite axial knob 313 by the user. FIG. 12 shows a schematic top plan view of the projection state when no external force is applied to the composite axial knob 313, and FIG. 13 shows a schematic top plan view of the projection state when an external force is applied to the composite axial knob 313. Even when no external is applied to the composite axial knob 313, the lines C-C and O-O are spaced apart from each other, and the lines C-C and O′-O′ are spaced further apart from each other. Of course, various design modifications may be made, such as forming a configuration in which the distance between the lines C-C and O′-O′ is smaller than that between the lines C-C and O-O.

The above-described configuration enables the composite switch unit 300 to detect changes in both the angular position and the axial position of the rotary axis. The axis of the axial rotation of the composite sensing moving part 320 may be arranged to be orthogonal to the normal to one surface of the substrate 200. By virtue of this configuration, when the composite axial knob 313 of the composite switch unit 300 moves linearly, it maintains a constant distance from the one surface of the substrate 200. This ensures that the distance between the composite sensing moving part 320 and either the substrate 20 or the composite sensing fixed part 330 remains constant as the linear position of the composite sensing moving part 320, which is disposed on the sensing holder 350, is changed.

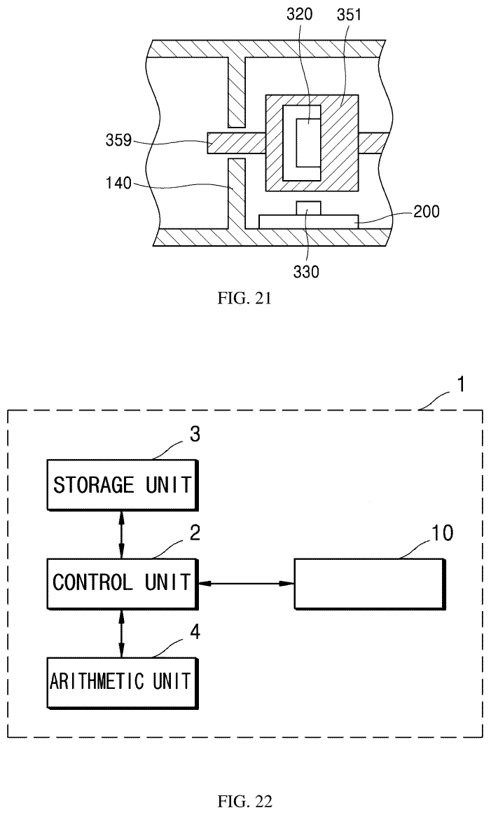

The multi-function switch device 10 of the present invention may further include an element that can continuously and stably maintain this uniform linear distance state. The housing 100 may further include a housing holder guide 140. The housing holder guide 140 may be formed extending inwardly from one surface of the housing cover 110 and/or the housing body 120 of the housing 100. The housing holder guide 140 is configured such that it is brought into supporting contact with at least one side of the composite sensing holder part 340 to guide the axial movement of the composite sensing holder part 340. As shown in FIG. 20, The housing holder guide 140 may be configured such that it is brought into contact with the holder-connecting shaft 353 of the sensing holder 350 of the composite sensing holder part 340, so that the older-connecting shaft 353 is rotatably supported by the housing holder guide 140. Further, as shown in FIG. 21, The sensing holder 350 may further include a holder body extension 359.

In some cases, the housing holder guide 140 is formed extending from the housing body 120 and penetrates through the substrate 200 to extend toward the sensing holder 350 so that the housing holder guide 140 can come into contact with the holder body extension 359 to support the sensing holder 350. The holder body extension 359 is formed extending from an end of holder body 351.

In the meantime, although the composite sensing moving part has been described focusing on the magnet in the previous embodiment, the composite sensing moving part 320a may include a ferromagnetic material. if necessary. That is, as shown in FIG. 16, the composite sensing moving part 320a includes a composite sensing moving protrusion 321a formed extending downwardly from the lower end thereof. The composite sensing fixed parts 330 detect the rotation “w” and the positional change “d” of the composite sensing moving protrusion 321a and output a changed signal.

On the other hand, the button switch unit 500 includes a button switch knob 510, a button switch sensing fixed part 520, and a button switch sensing moving part 530.

The button switch knob 510 is disposed so as to be exposed to the outside. The button switch sensing fixed part 520 is disposed on the substrate 200. The button switch sensing moving part 530 is connected at one end to the underside of the button switch knob 510. The button switch sensing moving part 530 is connected at the other end to the top of the button switch sensing fixed part 520 to form a signal change of the button switch sensing fixed part 520. That is, in this embodiment, the button switch sensing fixed part 520 is implemented as a push switch that is operated by the push operation. The pressing force applied to the button switch knob 510 is transmitted to the button switch sensing fixed part 520 through the button switch sensing moving part 530 so that the button switch sensing fixed part 520 generates a change in a predetermined electrical signal and transmits a changed switching signal to a main control unit (not shown) of a vehicle to transfer specific start state information.

The multi-function switch device 10 of the present invention may further include a light output means for guiding a manipulation position of the button switch knob 510 or informing an operation preparation state of the button switch unit 500 or whether to operate the button switch unit 500. The multi-function switch unit 10 includes a switch light source unit 600 that generate and provide a light which is to be outputted through the button switch unit 500.

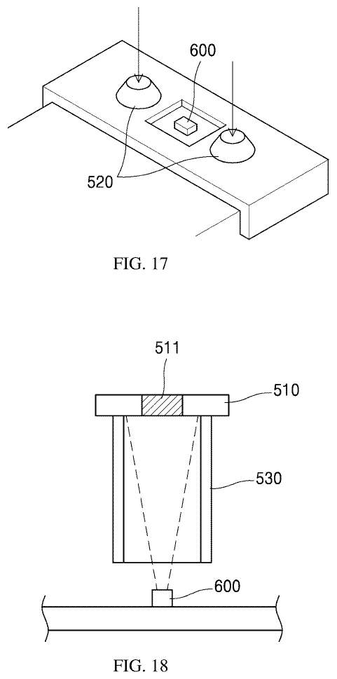

As shown in FIGS. 17 and 18, the switch light source unit 600 is disposed on the substrate 200. In FI. 17, each of the button switch sensing fixed parts 520 of the button switch unit 500 is implemented as a rubber pad, but the present invention is not limited thereto and may be configured in various manners, such as using a non-contact magnetic method. In FIG. 17, the rubber pad is partially exposed to the outside, and the switch light source unit 600 formed on one surface of the substrate 200 is positioned through a through-hole formed at the inner center of the button switch sensing moving part 530, which is connected to the underside of the button switch knob 510. The light exiting from the switch light source unit 600 is irradiated onto a button switch icon 11 formed on the button switch knob 510 through the through-hole of the inner center of the button switch sensing moving part 530, thereby enabling a predetermined light output function to be performed.

In the previous embodiments, the internal separation distances between the substrate 200 and the housing 100 at the points where the button switch unit 500 and the composite switch unit 300 of the present invention are located may be the same or different. This degree of design freedom allows for various modifications in the design layout structure of the button switch unit 500 and the exposed surface.

Further, in the previous embodiments, the substrate 200 has a configuration in which it is positioned inside the housing 100 in such a manner as to be disposed oppositely spaced apart from the exposed portion of the button switch unit 500. The composite switch unit 300 is at least partially disposed in a space defined between the substrate 200 and the exposed portion of the button switch unit 500. When the substrate 200 is disposed on the inner bottom surface of the housing body 120, the length of the button switch sensing moving part 530 is maximally secured, thereby minimizing the shaking of the button switch knob 510. In other words, the feel of manipulation of the button switch knob 510 can be improved.

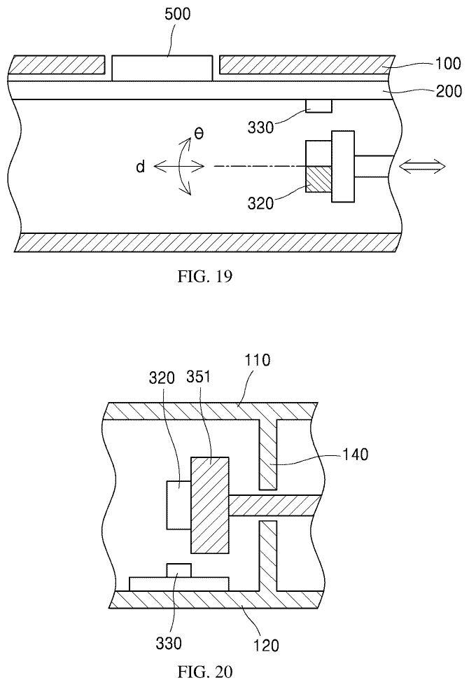

Meanwhile, the position of the substrate may be modified variously within the range in which a combined first and second switch is mounted on the single substrate to minimize the number of the substrates. In other words, the substrate 200 is positioned inside the housing 100 in such a manner as to be disposed in proximity to the exposed portion of the button switch unit (500). As shown in FIG. 19, the substrate 200 may be configured to be disposed in proximity to the underside of the housing over 110. In this case, for the button switch unit 500, a design selection may be made such as a simple capacitive switch, and the configuration of the composite switch unit 300 is the same as that of the previous embodiment. In such a case, the button switch unit 500 may be implemented as a combination of various functional selections, such as a button switch in a form of capable of ultrasonic sensing so that fingerprint recognition is performed. That is, the button switch unit 500 is implemented as an electronic switch in such a manner as to adopt both a combination method of providing the feel of physical operation through the composite switch unit 300, and a configuration of adding a separate haptic element to the button switch unit 500 as the electronic switch to add the feel of physical operation. As such, the button switch unit 500 may be selected in various manners.

By virtue of this configuration, the present invention may adopt a configuration of further minimizing the physical space to enable the thinness design of the product.

The above-described multi-function switch device may be implemented as various selection switches for a vehicle. The composite switch unit 300 may be a shift range selector switch that selects the shift range of the vehicle, and the button switch unit 500 may be a start switch for the vehicle. This is the same as the above-mentioned description.

In addition, the multi-function switch device 10 of the present invention is mounted on a multi-function switch module 1. The multi-function switch module (1) includes a storage unit 3 and a control unit 2, in addition to the multi-function switch device 10. The storage unit 3 may store a detected initial state value of at least one of the plurality of switch units and a preset value used as an operational state determination criterion of at least one of the plurality of switch units. The control unit 2 applies an arithmetic control signal to an arithmetic unit 4 using an actually detected state value or the preset value of at least one of the plurality of switch units, based on the initial state value stored in the storage unit 3, to derive an appropriate correction value, thereby performing a calibration as the zero-point adjustment of the detection sensor.

Accordingly, the multi-function switch device 10 and the multi-function switch module 1 may be released with a preset value stored, reflecting calibration matters based on the initial detection state at the time of product release. Further, the multi-function switch device 10 and the multi-function switch module 1 may by modified in various manners, such as adopting a configuration of detecting the initial value through a self-diagnosis and reflecting the detected initial value to perform the correction of the detected value at regular set intervals or at each condition achievement time point during use.

While the present invention has been described in connection with the exemplary embodiments illustrated in the drawings, they are merely illustrative and the invention is not limited to these embodiments. It will be appreciated by a person having an ordinary skill in the art that various equivalent modifications and variations of the embodiments can be made without departing from the spirit and scope of the present invention. Therefore, the scope of protection of the present invention should be interpreted by the appended claims, and it should be interpreted that all technical spirits within the scope equivalent to the claims fall within the scope of the present invention.

### INDUSTRIAL APPLICABILITY

Although the present invention has been implemented as a column-type switch that performs multi-functional operations, it may be applicable to applications in various fields within the range of controlling combined operations based on a column type.

1. A multi-function switch device (10) comprising a plurality of switch units (300, 300a, 500) disposed so as to be spaced apart from each other in a housing (100),
wherein each of the plurality of switch units is at least partially disposed on a single substrate (200).

2. The multi-function switch device (10) according to claim 1, wherein the plurality of switch units comprises:
a composite switch unit (300) configured to detect both an axial rotation about a shaft located at least partially within the housing (100) and an axial movement in an axial direction; and
a button switch unit (500) at one end disposed on the other peripheral surface of the housing (100) so as to be exposed to the outside.

3. The multi-function switch device (10) according to claim 2, wherein the composite switch unit (300) comprises:
a composite knob (310) disposed on the outer side of the hosing (100);
a composite sensing holder part (340) configured to be axially rotatable or movable in response to the movement of the composite knob (310);
a composite sensing moving part (320) disposed at the composite sensing holder part (340); and
a composite sensing fixed part (330) disposed on the substrate (200) so as to correspond to the position of the composite sensing moving part (320) and configured to detect the movement state of the composite sensing moving part (320).

4. The multi-function switch device (10) according to claim 3, wherein the composite sensing holder part (340) comprises:
a sensing holder (350) configured to allow the composite sensing moving part (320) to be disposed therein, the sensing holder (350) being movable relative to the composite knob (310); and
a sensing elastic part (360) configured to allow the sensing holder (350) to return its original position when an external force applied to the composite knob (310) for the axial movement of the sensing holder (350) is removed.

5. The multi-function switch device (10) according to claim 4, wherein
the sensing holder (350) comprises:
a holder body (351) configured to allow the composite sensing moving part (320) to be seated thereon;
a holder-connecting shaft (353) connected at one end to the holder body (351); and
a holder support (355) connected to the other end of the holder-connecting shaft (353) so to be movable relative to the housing (100).

6. The multi-function switch device (10) according to claim 5, wherein the holder support (355) has a non-circular cross-sectional shape.

7. The multi-function switch device (10) according to claim 3, wherein the composite sensing fixed part (330) is provided in a plural number.

8. The multi-function switch device (10) according to claim 7, wherein the respective distances between the center of the axial rotation of the composite sensing moving part (320) and the plurality of composite sensing fixed parts (330) are the same as each other on a plane perpendicular to the rotary axis of the composite sensing moving part (320).

9. The multi-function switch device (10) according to claim 7, wherein the respective distances between the center of the axial rotation of the composite sensing moving part (320) and the plurality of composite sensing fixed parts (330) are different from each other on a plane perpendicular to the rotary axis of the composite sensing moving part (320).

10. The multi-function switch device (10) according to claim 3, wherein when the composite sensing moving part (320) is projected onto the substrate (200), the composite sensing fixed parts (330) are overlapped with at least a part of the inside of the projection area of the composite sensing moving part (320).

11. The multi-function switch device (10) according to claim 3, wherein the normal to one surface of the substrate (200) and the axis of the axial rotation of the composite sensing moving part (320) are arranged to be orthogonal to each other.

12. The multi-function switch device (10) according to claim 3, wherein the housing 100 further comprises a housing holder guide (140) configured to guide the axial movement of the composite sensing holder part (340).

13. The multi-function switch device (10) according to claim 3, wherein the housing (100) further comprises a housing rotary guide (130) configured to guide the axial rotation of the composite sensing holder part (340).

14. The multi-function switch device (10) according to claim 3, wherein the composite knob (310) comprises:
a composite rotary knob (311) disposed at one end of the housing (100) so as to be axially rotatable; and
a composite axial knob (313) disposed at an end of the composite rotary knob (311) so as to be movable in the longitudinal direction of the rotary axis of the composite rotary knob (311).

15. The multi-function switch device (10) according to claim 3, wherein the composite sensing moving part (320) comprises a magnet or a ferromagnetic material.

16. The multi-function switch device (10) according to claim 2, wherein the button switch unit 500 comprises:
a button switch knob (510) disposed so as to be exposed to the outside;
a button switch sensing fixed part (520) disposed on the substrate (200); and
a button switch sensing moving part (530) connected at one end to the underside of the button switch knob (510) and connected at the other end to the top of the button switch sensing fixed part (520) to form a signal change of the button switch sensing fixed part (520).

17. The multi-function switch device (10) according to claim 2, wherein the substrate (200) is positioned inside the housing (100) in such a manner as to be disposed oppositely spaced apart from the exposed portion of the button switch unit (500), and the composite switch unit (300) is at least partially disposed in a space defined between the substrate (200) and the exposed portion of the button switch unit (500).

18. The multi-function switch device (10) according to claim 2, wherein the substrate (200) is positioned inside the housing (100) in such a manner as to be disposed in proximity to the exposed portion of the button switch unit (500).

19. The multi-function switch device (10) according to claim 2, wherein the composite switch unit (300) is a shift range selector switch configured to select the shift range of the vehicle, and the button switch unit (500) is a start switch for the vehicle.

20. A multi-function switch module (1) comprising:
a multi-function switch device (10) comprising a plurality of switch units (300, 300a, 500) disposed spaced apart from each other in a housing (100), wherein each of the plurality of switch units is at least partially disposed on a single substrate (200);
a storage unit (3) configured to a detected initial state value of at least one of the plurality of switch units and a preset value used as an operation state determination criterion of at least one of the plurality of switch units;
and a control unit (2) configured to calibrate an actually detected state value or the preset value of at least one of the plurality of switch units based on the initial state value stored in the storage unit.
